(19) United States
(12) Patent Application Publication
(10) Pub. No.: US 2009/0003140 A1
(43) Pub. Date: Jan. 1, 2009

(54) METHOD FOR WIRELESS PROGRAMMING OF A TIME SIGNAL RECEIVER, WIRELESSLY PROGRAMMABLE TIME SIGNAL RECEIVER, AND PROGRAMMING DEVICE FOR WIRELESS PROGRAMMING OF A TIME SIGNAL RECEIVER

(76) Inventors: Roland Polonio, Neckarsulm (DE); Hans-Joachim Sailer, Heilbronn (DE)

Correspondence Address: Muncy, Geissler, Olds & Lowe, PLLC, P.O. BOX 1364, FAIRFAX, VA, 22038-1364, US

(21) Appl. No.: 11/962,079

(22) Filed: Dec. 20, 2007

Related U.S. Application Data
(60) Provisional application No. 60/876,529, filed on Dec. 22, 2006.

(30) Foreign Application Priority Data
Dec. 20, 2006 (DE) DE 102006060924

(51) Int. Cl. G04C 11/02

(52) U.S. Cl. 368/47

(57) ABSTRACT

A method for wireless programming of a time signal receiver is, a wirelessly programmable time signal receiver, and a programming device for wireless programming of a time signal receiver, are provided. The method provides the following steps: transmitting a programming instruction, which is encoded in a data format adapted to a time signal receiver, by a transmitting device; wireless reception of the programming instruction by a receiver of a time signal receiver, which are set up to receive a time signal according to a predefinable time signal protocol; decoding of the programming instruction by the receiver and/or by the processor of the time signal receiver; and storage of the programming instruction, designated for execution in the receiver and/or in the processor, in the memory of the time signal receiver.

This nonprovisional application claims priority to German Patent Application No. DE 102006060924, which was filed in Germany on Dec. 20, 2006, and to U.S. Provisional Application No. 60/876,529, which was filed on Dec. 22, 2006, and which are both herein incorporated by reference.

### BACKGROUND OF THE INVENTION

1. Field of the Invention

The present invention relates to a method for wireless programming of a time signal receiver, a wirelessly programmable time signal receiver, and a programming device for wireless programming of a time signal receiver.

2. Description of the Background Art

The provision of precise time information is of basic importance for many applications in daily life. In various countries such as the USA, Japan, Russia, Germany, etc., precise time signals, which can be received by suitable receivers (time signal receivers), are provided by the appropriate national organizations. The time signals can be used for further processing, i.e., for the extraction of precise time information in appropriately equipped end devices, particularly in radio-controlled clocks or time-based measuring devices.

Radio waves, particularly in the long-wave frequency range from about 30 kHz to about 300 kHz, are a suitable medium for transmitting time signals. In the case of long-wave signals, particularly by amplitude modulation, encoded time signals have a very broad transmission range; they penetrate into buildings and can still be received with very small ferrite antennas. Obstacles such as trees and buildings cause high signal attenuation in the case of high-frequency satellite signals, but such obstacles have only a slight impact on the reception of long-wave signals.

The time signal is provided by a time signal transmitter, which transmits a signal sequence according to a predefined protocol. The national time signal transmitters differ both in the selected transmission frequency and in the configuration of the protocol. An example of a time signal transmitter is the long-wave transmitter DCF77 managed by the Physikalisch Technische Bundesanstalt (PTB) [Federal Physical and Technical Institute], which is controlled by several atomic clocks and transmits a time signal with a power of 50 KW at the frequency of 77.5 kHz during continuous operation. A more detailed description of the protocol for the time signal transmitted by the DCF77 station is the description provided hereinafter of FIGS. 1 and 2. Examples of other time signal transmitters are WWVB (USA), MSF (Great Britain), JJY (Japan), and BPC (China), which transmit time information on a long-wave frequency within the range between 40 and 120 KHz by means of amplitude-modulated signals.

In general, to transmit the time information, a time signal is transmitted within a time frame which is precisely 1 minute long. This time frame contains values for the minute, hour, calendar day, day of the week, month, year, etc., in the form of BCD codes (binary coded decimal codes), which are transmitted with a pulse duration modulation at 1 Hz per bit. In this case, either the rising or falling edge of the first pulse of a time frame is synchronized precisely with 0 seconds. A typical radio-controlled clock is made so that the setting of time occurs by receiving of the time information of one or a plurality of time frames from the point in time onward at which the zero second signal was first received.

FIG. 1 shows the coding scheme, designated by the reference character A, of the coded time information according to the protocol of time signal transmitter DCF77. The coding scheme in the present case includes 59 bits, each 1 bit corresponding to a second of the time frame. Over the course of a minute, a so-called time signal telegram, containing information on the time and date in binary coded form, can be transmitted therewith. The first 15 bits B contain a general coding, for example, operating information, and are not used at present. The next 5 bits C contain general information. Thus, the letter R designates the antenna bit, and A1 designates an announcement bit for the transition from Central European Time (MEZ) to Central European Summer Time (MESZ) and back again. Bits Z1 and Z2 designate time zone bits. A2 designates an announcement bit for a switching second and S designates a start bit for the encoded time information. Starting with bit 21 and up to bit 59, the time and data information are transmitted with a BCD code, whereby the data apply respectively to the next minute. The bits in area D contain information on the minute, in area E information on the hour, in area F information on the calendar day, in area G information on the day of the week, in area H information on the month, and in area I information on the calendar year. This information is provided in a bit-by-bit fashion in an encoded form. So-called test bits P1, P2, P3 are provided respectively at the ends of areas D, E, and 1. The sixtieth bit is vacant and serves to indicate the start of the next frame. M designates the minute mark and thus the start of the time signal.

The structure and bit allocation of the coding scheme, shown in FIG. 1, for transmitting time signals are generally known and described, for example, in an article by Peter Hetzel, “Time Information and Normal Frequency,” Telekom Praxis, Vol. 1, 1993.

The time signal information is transmitted amplitude modulated with the aid of individual second markers. The modulation comprises a reduction X1, X2 or an increase in the carrier signal X at the beginning of each second, whereby at the beginning of each second—with the exception of the fifty-ninth second of each minute—in the case of a time signal transmitted by the DCF77 transmitter, the carrier amplitude is reduced for 0.1 seconds X1 or for 0.2 seconds X2 to about 25% of the amplitude. These reductions of different duration each define a second marker or databit. This different duration of the second markers is used for the binary coding of the clock time and date, whereby second markers X1 with a duration of 0.1 seconds correspond to the binary “0” and those X2 with a duration of 0.2 seconds to the binary “1.” The absence of the sixtieth second marker announces the next minute marker. An evaluation of the time information sent by the time signal transmitter may then be performed in combination with the respective second. Using an example of a section, FIG. 2 shows this type of amplitude-modulated time signal, in which the encoding occurs by a reduction of the HF signal with a different pulse length.

Conventional time signal receivers, as they are described, for example, in the Unexamined German Patent Application No. DE 35 16 810 C2, receive the amplitude-modulated time signal emitted by the time signal transmitter and output it again demodulated as variably long pulses. This occurs in real time; i.e., a variably long pulse is generated per second at the output corresponding to the idealized time signal according to FIG. 2. In this case, the time information is thereby available encoded by the variably long pulses of the carrier. These pulses of different length are supplied by the time signal receiver to a microcontroller connected downstream. The microcontroller evaluates these pulses and determines whether corresponding to the length of this pulse a bit value of “1” or “0” is assigned to the specific pulse. This occurs by determining first the second beginning of a particular time frame of the time signal. If this second beginning is known, the bit value “1” or “0” can then be determined each time from the determined duration of the pulse. The microcontroller now takes up in sequence all 59 bits of a minute and based on the bit encoding of a specific second pulse determines which precise time and which precise date are present.

A time signal receiver made as a radio-controlled clock with a radio-controlled clockwork is known from the market, which is set up for receiving a time signal. To be able to adapt the radio-controlled clockwork to different operating conditions and optionally to enable blocking or release of functions of the radio-controlled clockwork, the radio-controlled clockwork is made programmable. That is to say, one or more programming instructions, which are encoded according to a programming protocol stored in the radio-controlled clockwork, can be fed to the radio-controlled clockwork to achieve the desired properties of the radio-controlled clockwork. Wired transmission of the programming instructions is provided for programming the radio-controlled clockwork. For the purpose of programming, the prior-art radio-controlled clock in the area of a battery compartment has a plurality of contact areas, which can be supplied with programming signals for the programming process in a programming device by mechanical contact needles. Therefore, to carry out the programming process, access to the contact areas must be left open, and further each wristwatch must be placed in the associated programming device for the programming. Instructions to unlock or block functions of the wristwatch or other parameters can be transmitted during the programming process. Functions of this type are customarily permanently programmed in the wristwatch and depending on the equipment features of the wristwatch made available or blocked for the user, so that the same radio-controlled clockwork can be used for wristwatches with a different range of functions.

Another programmable radio-controlled wristwatch is disclosed in German Patent Publication No. DE 196 25 041 A1. The disclosed radio-controlled wristwatch can be programmed at a later time by a transponder device, whereby the radio-controlled watch carrier frequency is among others used for transmitting the data. For this purpose, the wristwatch is shifted to a programming state via an external switch to be operated manually, which is integrated into the wristwatch.

### SUMMARY OF THE INVENTION

It is therefore an object of the present invention to provide a method for programming a time signal receiver, a time signal receiver, and a programming device for programming a time signal receiver, which enable simplified programming.

The method of the invention for wireless programming of a time signal receiver comprises the following steps: transmitting a programming instruction, which is encoded in a data format adapted to a time signal receiver, by a transmitting device; wireless reception of the programming instruction by the receiver of a time signal receiver, which are set up to receive a time signal according to a predefinable time signal protocol; decoding of the programming instruction by the receiver and/or by the processor of the time signal receiver; and storage of the programming instruction, designated for execution in the receiver and/or in the processor, in the memory of the time signal receiver. Simultaneous programming of a plurality of time signal receivers is possible by the method of the invention, because the programming instructions are transmitted without mechanical contact between a programming device and the time signal receiver. It is therefore possible to realize programming of a time signal receiver also during mass production, without an uneconomically large number of programming devices being necessary for this. Moreover, contact areas for wired coupling of the programming instructions can be eliminated, as a result of which simplification of the time signal receiver can be realized. It is possible in addition to program the time signal receiver without direct mechanical access also after integration into a more complex unit, for example, into a measuring device or into a household device. An updating of programming instructions at a later time after completion of the time signal receiver is also conceivable. It is critical that for the programming of the time signal receiver the access provided for the reception of the time signal is used to effect a wireless or contactless transmission of programming instructions. To carry out the method, a programming instruction, written in a format decodable by the time signal receiver, is made available to the time signal receiver. By means of a first programming instruction, the time signal receiver can be made ready to receive additional programming instructions. The receiver of the time signal receiver are in particular an analog receiver arrangement, as described in the Unexamined German Patent Application No. DE 103 34 990, which corresponds to U.S. Publication No. 2005/0036514, which is incorporated herein by reference. The processor can be made, for example, as a state machine or as a microcontroller. The processor are assigned internally integrated or separately made memory for storing at least one program instruction.

An embodiment of the invention provides that to program the time signal receiver, at least one complete time signal is transmitted according to the time signal protocol, which in addition comprises a number of programming instructions. In this type of procedure, which can be used in particular for the time signal of the German DCF77 transmitter, transmission of programming instructions is possible without the transmission of the time signal having to be eliminated. According to the protocol of the DCF77 time signal, the first 15 bits are freely available within the time frame, which in the case of DCF77 has a duration of 60 seconds, and can therefore be used for transmitting a first programming instruction (first bit in the DCF77 protocol), serving as a programming status signal, and for transmitting other programming instructions (2^{nd} to 15^{th} bit in the DCF77 protocol). Therefore, programming of the time signal receiver and synchronization of the time signal receiver to the time signal to be transmitted for programming can be performed simultaneously. After a programming phase is completed, therefore, the full functionality of the time signal receiver including the capability for correct synchronization to the time signal can be checked immediately. The disadvantage of a low data rate for programming instruction transmission within the scope of the time signal (in the case of the DCF77 protocol 14 usable bits per minute), which can take several minutes, is easily lessened by the fact that a plurality of time signal receivers can be programmed wirelessly simultaneously by a single programming device.

Another embodiment of the invention provides that to program the time signal receiver, in a first step a time signal is transmitted, which comprises at least one programming instruction for switching the time signal receiver to a programming protocol, and that in other steps programming instructions are transmitted according to a programming protocol stored in the time signal receiver. This type of procedure may be used when the time signal receiver is provided for a time signal protocol in which only a few bits or even only one bit is freely available, as is the case in most time signal protocols. For programming, a time signal is first made available to the time signal receiver according to the respective protocol, in which at least one free bit is set according to a protocol stored in the time signal receiver so that during the decoding in the time signal receiver it can be recognized that a programming process is planned. The time signal receiver switches to a programming state upon arrival of the appropriate bit. In the programming state, the programming device uses a programming protocol different from the time signal protocol and stored in the time signal receiver for decoding the programming instructions.

Another embodiment of the invention provides that to program the time signal receiver, programming instructions are transmitted in a programming protocol different from the time signal and stored in the time signal receiver. The time signal receiver can be set up in such a way that it examines the incoming signals to determine whether they are time signals or programming instructions. The time signal receiver can also be set up in such a way that it is switched to the programming state by means of a parameter linked to the time signal, for example, by means of the field strength of the time signal, or by a parameter independent of the time signal, for example, by a programming status signal sent by the programming device. A preferred embodiment of the invention provides that the programming signal for switching to the programming state is derived from the time signal field strength. The variable amplification of the adjustable amplifier provided in the receiver can be used in particular in this case. An incoming signal with a high field strength is detected based on a minimal amplification and indicates to the time signal receiver that programming with a programming device is to be carried out.

Another embodiment of the invention provides that the time signal receiver upon receiving the programming instruction is switched to the programming state for a predefinable time period. This assures that the time signal receiver always enters the receive state for the time signal also if the programming process is not fully completed.

Another embodiment of the invention provides that the time signal receiver is switched to the programming state when the programming instructions are received until a reset instruction arrives. As a result, a variable number of programming instructions can be transmitted to the time signal receiver. Upon arrival of the reset instruction, the time signal receiver switches back to the receive state for the time signal and can be tested, for example, immediately after the programming process for its reception properties for the time signal. This is an advantage, when different production batches of time signal receivers are to be programmed with very different amounts of programming instructions. When the number of programming instructions to be transmitted is low, the function test with the time signal can be performed even after short time. When there are many programming instructions, switching back to the receive state occurs only after they are all transmitted.

Another embodiment of the invention provides that release or blocking of functions, permanently predefine in the time signal receiver, is performed in the programming state. The functions are provided in the layout, i.e., in the hardware of the time signal receiver, and can be blocked or released with use of internal pointers, i.e., by software. In carrying out the programming process, the particular pointers are set in accordance with the specification by the programming device and thereby determine the range of functions of the time signal receiver. A typical use for such releasable and blockable functions is stopwatch or calendar functions in a wristwatch with a radio-controlled clockwork. In the radio-controlled clockwork, these functions are all applied on the hardware side and depending on the wristwatch model are released or blocked on the software side by wireless programming.

In an embodiment of the invention, a final blocking of the programming state is specified after a single programming run. This type of blocking can be brought about particularly by setting of an internal pointer in the receiver or in the processor or by separating one or more electrical connections in the time signal receiver, for example, by a signal with a high field strength radiated in from outside. This prevents a subsequent change of the program instructions transmitted during the programming process, which is of particular interest in the setting of different ranges of functions for the time signal receiver.

It is provided in another embodiment of the invention that in the programming state a freely programmable instruction sequence, designated for execution by the receiver and/or the processor, is stored in the memory. With a freely programmable instruction sequence, functions can be implemented in the time signal receiver, which are not already stored in the layout of the time signal receiver. These can be, for example, country-specific parameters for decoding the time signal or extra software, which is to run in the time signal receiver.

According to another aspect of the invention, a programmable time signal receiver is proposed, which has receiver for wireless receiving of an electromagnetic time signal and/or a programming instruction and processor for processing the time signal and/or programming instructions, whereby the receiver and/or the processor are assigned memory, formed for temporary storage of programming instructions and for supplying the instructions to the receiver and/or to the processor, whereby the receiver and/or the processor are set up to derive programming instructions from the time signal and/or from a programming signal and to store the programming instructions in the memory. The programming signal here is a programming device signal encoded with a plurality of programming instructions and based on a programming protocol different from the time signal protocol.

According to another aspect of the invention, a programming device is proposed for wireless programming of a time signal receiver having memory for storing instructions for the time signal receiver and having a transmitting device, particularly a long-wave transmitting device, to provide an electromagnetic signal, and having a control device, which is set up to encode the instructions in the electromagnetic signal. With a programming device of this type, a plurality of time signal receivers can be programmed simultaneously, because no mechanical contact between the time signal receiver and the programming device is necessary. Preferably, the programming device is installed in an electromagnetically shielded space and the time signal receivers to be programmed are brought, optionally in large numbers, into the electromagnetic field emitted by the programming device. Depending on the construction of the time signal receiver and the programming device, particularly in the case of time signal receivers set up to receive and evaluate time signals according to the DCF77 protocol, a parallel or a sequential execution of programming and a function test directed to the time signal receiver are carried out.

It is provided in another embodiment of the invention that the control device for encoding a time signal with programming instructions according to a predefinable time signal protocol and for encoding a programming instruction according to a predefinable programming protocol for time signal receivers can be switched. Therefore, the programming device in addition to its programming function can also be used for time signal receivers that are not provided for simultaneous execution of programming and time signal receiving, in a simple and cost-effective way as a testing device for the time signal receiving.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given byway of illustration only, and thus, are not limitive of the present invention, and wherein:

FIG. 1 shows a schematic graphic depiction of a time signal, which is encoded according to the protocol of the time signal transmitter DCF77;

FIG. 2 shows part of an idealized time signal with 5 second pulses;

FIG. 3 shows a block diagram of a time signal receiver in greatly simplified form;

FIG. 4 shows a detailed block diagram of part of the time signal receiver according to FIG. 3; and

FIG. 5 shows a schematic drawing of a programming device for a plurality of time signal receivers according to an embodiment of the invention.

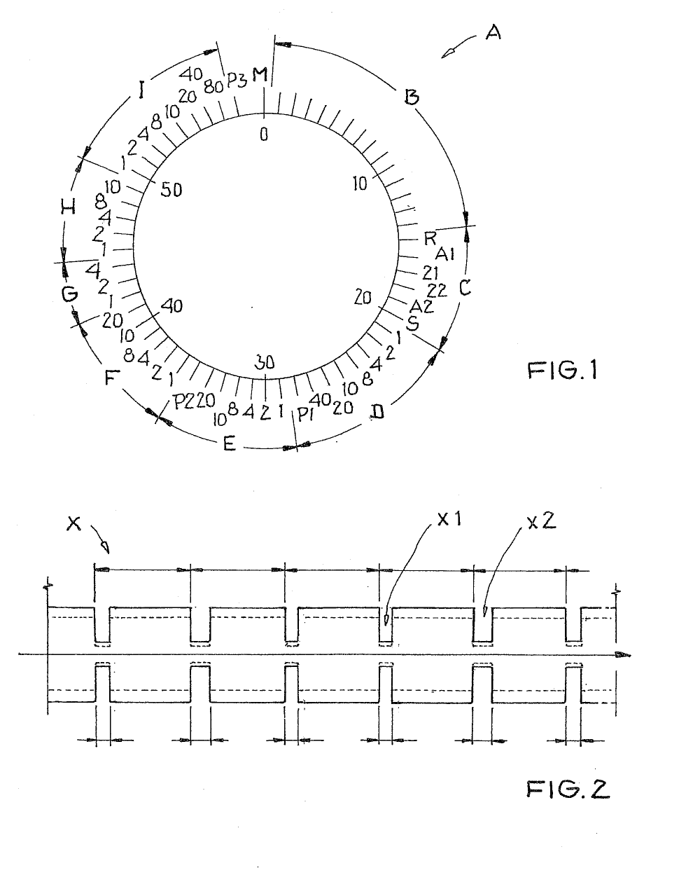

### DETAILED DESCRIPTION

The same or functionally equivalent elements, signals, and functions, if not indicated otherwise, are designated with the same reference characters in all figures of the drawing.

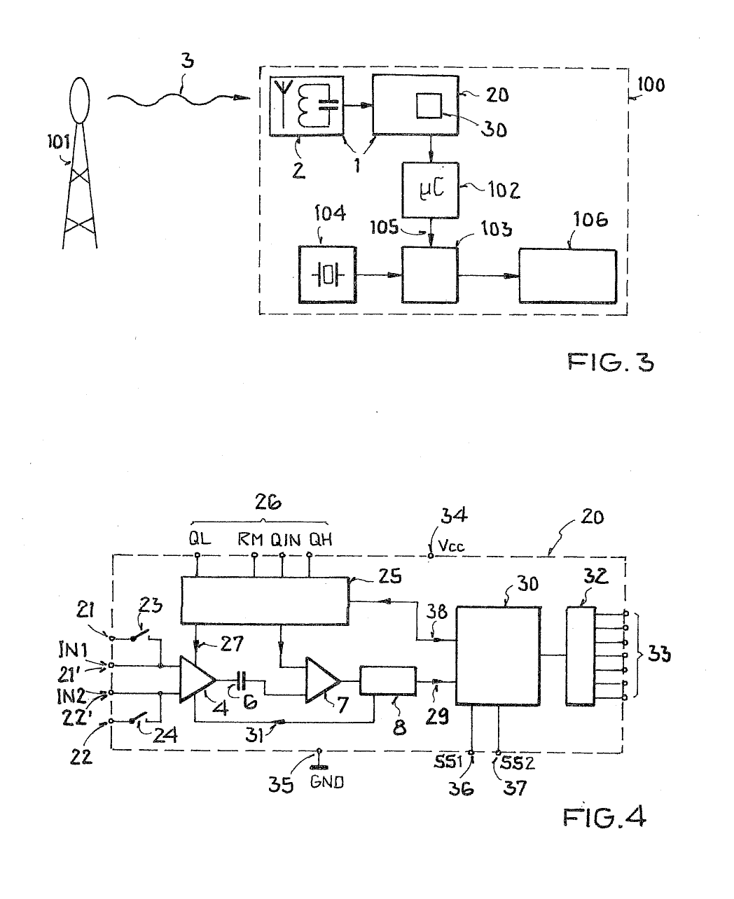

The basic structure and operating mode of a time signal receiver are known from Unexamined German Patent Application No. DE 35 16 810. FIG. 3 shows a block diagram of a greatly simplified time signal receiver, which is formed in the present case as radio-controlled clock 100. Radio-controlled clock 100 has an antenna 2 for picking up time signal 3 transmitted by a time signal transmitter 101. An integrated circuit 20 with a logic and control unit 30 is connected to antenna 2. Antenna 2 and integrated circuit 20 together form receiver 1. A program-controlled unit, made as microcontroller of 102 in the form of processor, is connected downstream of the outputs of receiver 1. Microcontroller 102 takes up the databits generated by the receiver, calculates a precise time and date from these, and generates therefrom a signal 105 for the time and date. Radio-controlled clock 100, further, has an electronic clock 103 whose time is controlled by a clock crystal 104. Electronic clock 103 is connected to an indicator 106, for example, a display, by which the time is indicated.

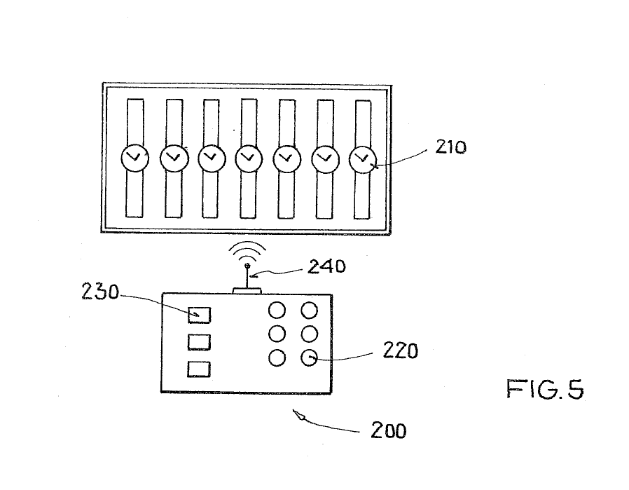

FIG. 4 shows the time signal receiver part, made as integrated circuit 20, using a detailed block diagram. Integrated circuit 20 has two inputs 21, 22 for connection to one or two antennas, which are not shown. By providing two or more antennas, it is possible to tune receiver 1 to different time signal transmitters, which operate in different wavelengths ranges, by switching between the antennas. A frequency or antenna switch can be made by the switching. A control amplifier 4 can be connected to one of the antenna inputs 21, 22 each by controllable switches 23, 24. The other input of control amplifier 4 is connected to inputs 21′, 22′. A reference signal IN1, IN2, for example, can be coupled into these inputs. Control amplifier 4 is connected on the output side to an input of a postamplifier 7. A filter 6, which is formed as a capacitor and with which parasitic capacitances between inputs QL-QH can be compensated, is disposed in-between.

Integrated circuit 20 further has a switching unit 25. Switching unit 25 has, for example, a plurality of switchable filters at inputs QL-QH, by means of which switching unit 25 is designed to provide several frequencies on the output side. These frequencies can be set via control inputs 26, 36, 37 of switching unit 25. Control amplifier 4 can be influenced, particularly controlled, by control signal 27 provided by switching unit 25. Switching unit 25 further generates an output signal 28, which is coupled into a second input of postamplifier 7. Postamplifier 7 controls rectifier 8 connected downstream. Rectifier 8 generates a control signal 31 (AGC signal=Automatic Gain Control), which controls control amplifier 4. Rectifier 8 on the output side further generates an output signal 29, for example, a rectangular output signal 29 (TCO signal), which is supplied to a logic and control unit 30 connected downstream.

Logic and control unit 30 is connected to an input/output device 32 (I/O unit), which is connected to input/output terminals 33 of integrated circuit 20. The time signals, inter alia, processed, decoded, and stored in logic and control unit 30 can be tapped at these terminals 33. A microcontroller, connected downstream of integrated circuit 20 and not shown in FIG. 4, or a state machine with a rather simple structure, if required, can read out these time signals just stored and decoded in logic and control unit 30. A clock signal can be supplied via terminals 33 to integrated circuit 20 or logic and control unit 30.

For further control of switching unit 25, said unit is connected to logic and control unit 30 and controls logic and control unit 30 with a control signal 38. The integrated circuit further has terminals 36, 37, via which logic and control unit 30 can be supplied with control signals SS1, SS2.

FIG. 5 shows a programming device 200, which is provided for simultaneous programming of a plurality of time signal receivers 210 made as radio-controlled wristwatches. Programming device 200 has several control buttons 220, 230, which are provided for setting the programming process or for setting the functions to be released in the time signal receiver. Programming device 200 has an antenna 240 for sending out a long-wave time signal or programming signal, so that a wireless programming or transmission of a time signal to time signal receiver 210 can be carried out.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for wireless programming of a time signal receiver (100, 210) comprising the steps:
transmitting a programming instruction, which is encoded in a data format adapted to a time signal receiver, by a transmitting device;
receiving wirelessly the programming instruction by a receiver of a time signal receiver, which are set up to receive a time signal according to a predefinable time signal protocol;
decoding the programming instruction by the receiver and/or by the processor of the time signal receiver; and
storaging the programming instruction, designated for execution in the receiver and/or in the processor, in the memory of the time signal receiver,
wherein, to program the time signal receiver, at least one complete time signal is transmitted according to the time signal protocol, which in addition comprises at least one programming instruction.

2. The method according to claim 1, wherein, to program the time signal receiver, in a first step a time signal is transmitted, which comprises at least one programming instruction for switching the time signal receiver to a programming protocol, and in other steps programming instructions are transmitted according to a programming protocol stored in the time signal receiver.

3. The method according to claim 1, wherein to program the time signal receiver, programming instructions are transmitted in a programming protocol different from the time signal protocol and stored in the time signal receiver.

4. The method according to claim 3, wherein the programming signal for switching to a programming state is derived from the time signal field strength.

5. The method according to claim 4, wherein the time signal receiver upon receiving the programming instruction is switched to the programming state for a predefinable time period.

6. The method according to claim 4, wherein the time signal receiver is switched to the programming state when the programming instructions are received until a reset instruction arrives.

7. The method according to claim 4, wherein release or blocking of functions, permanently predefined in the time signal receiver, is performed in the programming state.

8. The method according to claim 3, wherein in the programming state a freely programmable instruction sequence, designated for execution by the receiver and/or the processor, is stored in the memory.

9. A programmable time signal receiver comprising:
a receiver for receiving wirelessly an electromagnetic time signal and/or a programming instruction; and
a processor for processing the time signal and/or a programming signal,
wherein the receiver and/or the processor are assigned to a memory provided for temporary storage of instructions and for supplying the instructions to the receive and/or to the processor, and
wherein the receiver and/or the processor are set up to derive programming instructions from the time signal and/or from a programming signal and to store the programming instructions in the memory.

10. A programming device for wireless programming of a time signal, the device comprising:
a memory for storing instructions for the time signal receiver;
a transmitting device or a long-wave transmitting device, to provide an electromagnetic signal, which comprises at least one complete time signal according to a time signal protocol; and
a control device, which is set up to encode the instructions in the electromagnetic signal.

11. The programming device according to claim 10, wherein the control device for encoding a time signal with programming instructions according to a predefinable time signal protocol and for encoding a programming signal according to a predefinable programming protocol for time signal receivers is switched.
